(19) United States
(12) Patent Application Publication
(10) Pub. No.: US 2010/0059074 A1
(43) Pub. Date: Mar. 11, 2010

(54) Inspection System for a Smoking Article Having an Object Inserted Therein, and Associated Method

(75) Inventors: Franklin Forrest Brantley, Winston-Salem, NC (US); Van Loren Gough, Kernersville, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: R. J. Reynolds Tobacco Company

(21) Appl. No.: 12/205,285

(22) Filed: Sep. 5, 2008

(51) Int. Cl. A24C 5/32; G06K 9/00; H04N 5/225

(52) U.S. Cl. 131/280; 382/143; 348/207.1; 348/E05.024

(57) ABSTRACT

A system and associated method is provided for inspecting filter rods used to form cigarette filter elements, wherein each filter rod defines a longitudinal axis extending between opposed ends, with each end extending substantially perpendicularly to the longitudinal axis, and includes a filter material having an axially-extending strand disposed therein. A filter rod support device is adapted to receive at least one filter rod such that one end thereof is exposed. An analysis unit is disposed with respect to the filter rod support device so as to interact with the one end of the at least one filter rod to determine a status of the at least one filter rod and to provide a corresponding signal in response thereto.

### BACKGROUND OF THE INVENTION

1. Field of the Invention

Embodiments of the present invention relate to apparatuses and methods for inspecting smoking articles, and components of smoking articles, such as filter elements. In particular, embodiments of the present invention relate to apparatuses and methods for inspecting a filter rod component having an object, such as a continuous strand, inserted therein, wherein the filter rod component is used to manufacture a filter element for a smoking article, such as a cigarette.

2. Description of Related Art

Popular smoking articles, such as cigarettes, generally have a substantially cylindrical rod shaped structure and include a charge, roll or column of smokable material, such as shredded tobacco (e.g., in cut filler form), surrounded by a paper wrapper, thereby forming a so-called “smokable rod” or “tobacco rod.” Normally, a cigarette has a cylindrical filter element aligned in an end-to-end relationship with the tobacco rod. Typically, a filter element comprises cellulose acetate tow, plasticized using triacetin, wherein the tow is circumscribed by a paper material known as “plug wrap.” A cigarette can incorporate a filter element having multiple segments, and one of those segments can comprise activated charcoal particles. See, for example, U.S. Pat. No. 6,537,186 to Veluz; PCT Publication No. WO 2006/064371 to Banergea; and U.S. Patent Application Publication No. 2007/0056600 to Coleman III, et al.; each of which is incorporated herein by reference. The filter element may be attached to one end of the tobacco rod using a circumscribing wrapping material known as “tipping paper,” in order to provide a so-called “filtered cigarette.” It also has become desirable, in some instances, to perforate the tipping material and plug wrap, in order to provide dilution of drawn mainstream smoke with ambient air. Descriptions of cigarettes and the various components thereof are set forth in Tobacco Production, Chemistry and Technology, Davis et al. (Eds.) (1999). The resulting cigarette is employed by a smoker by lighting one end thereof and burning the tobacco rod. The smoker then receives mainstream smoke into his/her mouth by drawing on the opposite end (e.g., the filter end) of the cigarette.

Various attempts to alter the visual attributes of cigarettes have been proposed. For example, there have been attempts to alter the color of the wrapping materials of the tobacco rod (e.g., cigarettes marketed under the trade name “More” by R. J. Reynolds Tobacco Company possess cigarette rod wrapping papers exhibiting a brown color) and/or tipping materials used to attach the tobacco rod to the filter element (e.g., tipping materials have been printed so as to possess a “cork” appearance and/or to possess at least one circumscribing ring). In addition, there have been attempts to alter the appearance of the filter elements of cigarettes. See, for example, the types of cigarette filter element formats, configurations and designs set forth in U.S. Pat. No. 3,596,663 to Schultz; U.S. Pat. No. 4,508,525 to Berger; U.S. Pat. No. 4,646,763 to Nichols; U.S. Pat. No. 4,655,736 to Keith; U.S. Pat. No. 4,726,385 to Chumney, Jr.; U.S. Pat. No. 4,807,809 to Pryor et al.; and U.S. Pat. No. 5,025,814 to Raker; and U.S. Patent Application Publication No. 2007/0215167 to Crooks et al.; each of which is incorporated herein by reference.

The sensory attributes of cigarette smoke can be enhanced by applying additives to tobacco and/or by otherwise incorporating flavoring materials into various components of a cigarette. See, Leffingwell et al., Tobacco Flavoring for Smoking Products, R.J. Reynolds Tobacco Company (1972). For example, one type of tobacco flavoring additive is menthol. See, Borschke, Rec. Adv. Tob. Sci., 19, p. 47-70, 1993. Various proposed methods for modifying the sensory attributes of cigarettes have involved the suggestion that filter elements may be used as vehicles for adding flavor to the mainstream smoke of those cigarettes. For example, U.S. Patent Application Publication No. 2002/0166563 to Jupe et al. proposes the placement of adsorbent and flavor-releasing materials in a cigarette filter, while U.S. Patent Application Publication No. 2002/0020420 to Xue et al. proposes the placement of fibers containing small particle size adsorbents/absorbents in the filter. U.S. Pat. No. 4,941,486 to Dube et al. and U.S. Pat. No. 4,862,905 to Green, Jr. et al., which are incorporated herein by reference, propose manners and methods for the placement of a flavor-containing pellet in each cigarette filter. Other representative types of cigarette filters incorporating flavoring agents are set forth, for example, in U.S. Pat. No. 3,972,335 to Tiggelbeck et al.; U.S. Pat. No. 4,082,098 to Owens, Jr.; U.S. Pat. No. 4,281,671 to Byrne; U.S. Pat. No. 4,643,205 to Redding et al.; U.S. Pat. No. 4,677,995 to Kallianos et al.; U.S. Pat. No. 4,715,390 to Nichols et al.; U.S. Pat. No. 4,729,391 to Woods et al.; U.S. Pat. No. 4,768,526 to Pryor; U.S. Pat. No. 5,012,829 to Thesing et al.; U.S. Pat. No. 5,387,285 to Rivers; and U.S. Pat. No. 7,074,170 to Lanier, Jr. et al.; each of which is incorporated herein by reference. See, also, the types of cigarette filter technologies that are discussed in the background art section set forth in U.S. Patent Application Publication No. 2004/0261807 to Dube et al.; which is incorporated herein by reference.

To that end, apparatuses and processes have been developed for providing filter rods for use in the manufacture of smoking articles, wherein each rod has one or more strands disposed within and extending axially along its length such that, when the rod is subdivided into rod portions, each rod portion includes at least one strand extending between the opposed ends of thereof. Such apparatuses can incorporate equipment for supplying a continuous supply of filter material (e.g., a filter tow processing unit adapted to supply filter tow to a continuous rod forming unit). A representative apparatus may include, for example, an arrangement such as disclosed in U.S. Patent Application Publication No. US 2008/0029118 A1 to Nelson et al., which is incorporated herein by reference, for supplying a strand to the filter material during the production of filter rods. Typically, during the manufacturing process, the filter material is formed into a continuous rod having the strand positioned within that rod and along the longitudinal axis thereof. The continuous rod then is subdivided at predetermined intervals so as to form a plurality of filter rods or rod portions such that each rod portion includes at least one of the strands therein extending between the opposed ends of thereof.

However, in some instances, it is possible that such apparatuses and processes for inserting a strand within the filter rod may produce some filter rods or portions thereof that are not formed in the desired configuration. That is, the strand inserted within a filter rod may be, for instance, missing, misaligned, or otherwise improperly inserted. Further, the strand may be, for example, an improper color, an improper size, or an improper material. Any or all of these factors may undesirably affect, for example, the aesthetic quality, or in some instances the functionality, of the end product. As such, it may be desirable to be able to detect such “abnormal” filter rods or portions thereof, after the rod portions have been formed, such that those “abnormal” filter rods, or at least the defective portion(s) thereof, can be removed from the manufacturing process prior to being used to form the smoking articles. In this manner, for example, the yield of the manufacturing process for such smoking articles may be increased, and smoking articles having such “abnormal” filter rods may be prevented from reaching consumers. Thus, there exists a need for a system and/or method for detecting any or all of a variety of abnormalities in filter rod portions, each having a strand disposed therein, prior to any abnormal rod portions being incorporated into a smoking article.

### BRIEF SUMMARY OF THE INVENTION

The above and other needs are met by embodiments of the present invention, which provide apparatuses and methods for inspecting filter rods used in manufacturing smoking articles, such as cigarettes, wherein such filter rods, as will be appreciated by one skilled in the art, are formed such that each such filter rod includes a filter material having a filament material (e.g., at least one strand) extending axially/longitudinally along the length thereof. In forming such filter rods, a continuous supply of filter material (e.g., provided using a filter tow processing unit) is provided to a continuous filter rod forming unit. The continuous rod forming unit generally possesses a garniture region for receiving filter material that has been fashioned into a generally cylindrical shape, and either (i) wraps the continuous supply of gathered filter material so provided within a circumscribing web of plug wrap, or (ii) steam bonds the plasticized filter material. A spool, bobbin, or other mechanism may provide a continuous supply of filter material for fashioning into the generally cylindrical shape, prior to being directed through the garniture region of the rod forming unit. In some instances, a strand insertion mechanism may be provided for inserting a continuous strand into the filter material, and is configured and positioned so as to allow for feeding and positioning of that strand material into a selected disposition within the filter material. As such, the filter material is formed into a continuous rod having a continuous strand extending longitudinally through that rod, with the strand extending generally parallel to the longitudinal axis of the rod. The continuous rod may then be subdivided at predetermined longitudinal intervals so as to form a plurality of filter rods or rod portions (e.g., four-up, generally cylindrical filter rod portions, each containing a strand that extends generally longitudinally therethrough, between opposed ends of the filter rod portions).

Because it may be desirable to verify characteristics (i.e., strand presence, strand alignment, strand type) of the strand inserted in the filter rods or rod portion, one aspect of the present invention is a system for inspecting filter rods used to form cigarette filter elements, wherein each filter rod defines a longitudinal axis extending between opposed ends, with each end extending substantially perpendicularly to the longitudinal axis, and includes a filter material having an axially-extending strand disposed therein. Such a system comprises a filter rod support device adapted to receive at least one filter rod such that one end thereof is exposed. An analysis unit is disposed with respect to the filter rod support device so as to interact with the one end of the at least one filter rod to determine a status of the at least one filter rod and to provide a corresponding signal in response thereto.

Another aspect of the present invention is a system for inspecting filter rods used to form cigarette filter elements, wherein each filter rod defines a longitudinal axis extending between opposed ends, with each end extending substantially perpendicularly to the longitudinal axis, and includes a filter material having an axially-extending strand disposed therein. Such a system comprises filter rod support means adapted to receive at least one filter rod such that one end thereof is exposed. Analysis means is disposed with respect to the filter rod support means so as to interact with the one end of the at least one filter rod to determine a status of the at least one filter rod and to provide a corresponding signal in response thereto.

Still another aspect of the present invention is a method for inspecting filter rods used to form cigarette filter elements, wherein each filter rod defines a longitudinal axis extending between opposed ends, with each end extending substantially perpendicularly to the longitudinal axis, and includes a filter material having an axially-extending strand disposed therein. Such a method comprises receiving at least one filter rod in a filter rod support device such that one end of the at least one filter rod is exposed, and analyzing the one end of the at least one filter rod using an analysis unit. A status of the at least one filter rod is determined from the analysis of the one end, and a signal is provided in response to and corresponding to the determined status.

Embodiments of the present invention thus provide significant advantages as further detailed herein.

### BRIEF DESCRIPTION OF THE SEVERAL VIEWS OF THE DRAWINGS

Having thus described various embodiments of the invention in general terms, reference will now be made to accompanying drawings, which are not necessarily drawn to scale, and wherein:

FIG. 1 is an exploded view of a smoking article having the form of a cigarette, showing the smokable material, the wrapping material components, and a filter element;

FIG. 2a is a cross-sectional view of a smoking article having the form of a cigarette, showing the smokable material, the wrapping material components, and a filter element, which includes a continuous strand inserted therein;

FIG. 2b is an end view of a representative filter element of a smoking article, showing the filter material and the continuous strand disposed about the center of the filter material;

FIG. 3 is a cross-sectional view of a representative filter rod including filter material and a continuous strand inserted therein;

FIG. 4 is a schematic of a system for inspecting filter rods used to form cigarette filter elements, according to one embodiment of the present invention;

FIGS. 5 and 6 are various views of a system for inspecting filter rods used to form cigarette filter elements, according to the embodiment shown in FIG. 4;

FIG. 7 illustrates a system for inspecting filter rods used to form cigarette filter elements, according to an alternate embodiment of the present invention;

FIG. 8 illustrates an analysis of a filter rod used to form cigarette filter elements, according to the embodiment shown in FIG. 7;

FIG. 9 illustrates a system for inspecting filter rods used to form cigarette filter elements, according to another alternate embodiment of the present invention; and

FIG. 10 illustrates an analysis of a filter rod used to form cigarette filter elements, according to the embodiment shown in FIG. 9.

### DETAILED DESCRIPTION OF THE PREFERRED EMBODIMENTS

The present invention now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Cigarette rods are manufactured using a cigarette making machine, such as a conventional automated cigarette rod making machine. Exemplary cigarette rod making machines are of the type commercially available from Molins PLC or Hauni-Werke Korber & Co. KG. For example, cigarette rod making machines of the type known as MkX (commercially available from Molins PLC) or PROTOS (commercially available from Hauni-Werke Korber & Co. KG) can be employed. A description of a PROTOS cigarette making machine is provided in U.S. Pat. No. 4,474,190 to Brand, at col. 5, line 48 through col. 8, line 3, which is incorporated herein by reference. Types of equipment suitable for the manufacture of cigarettes also are set forth in U.S. Pat. No. 4,781,203 to La Hue; U.S. Pat. No. 4,844,100 to Holznagel; U.S. Pat. No. 5,156,169 to Holmes et al.; U.S. Pat. No. 5,191,906 to Myracle, Jr. et al.; U.S. Pat. No. 6,647,870 to Blau et al.; U.S. Pat. No. 6,848,449 to Kitao et al.; and U.S. Pat. No. 6,904,917 to Kitao et al.; and U.S. Patent Application Publication Nos. 2003/0145866 to Hartman; 2004/0129281 to Hancock et al.; 2005/0039764 to Barnes et al.; and 2005/0076929 to Fitzgerald et al.; each of which is incorporated herein by reference.

The components and operation of conventional automated cigarette making machines will be readily apparent to those skilled in the art of cigarette making machinery design and operation. For example, descriptions of the components and operation of several types of chimneys, tobacco filler supply equipment, suction conveyor systems and garniture systems are set forth in U.S. Pat. No. 3,288,147 to Molins et al.; U.S. Pat. No. 3,915,176 to Heitmann et al; U.S. Pat. No. 4,291,713 to Frank; U.S. Pat. No. 4,574,816 to Rudszinat; U.S. Pat. No. 4,736,754 to Heitmann et al. U.S. Pat. No. 4,878,506 to Pinck et al.; U.S. Pat. No. 5,060,665 to Heitmann; U.S. Pat. No. 5,012,823 to Keritsis et al. and U.S. Pat. No. 6,360,751 to Fagg et al.; and U.S. Patent Application Publication No. 2003/0136419 to Muller; each of which is incorporated herein by reference. The automated cigarette making machines of the type set forth herein provide a formed continuous cigarette rod or smokable rod that can be subdivided into formed smokable rods of desired lengths.

Filtered cigarettes incorporating filter elements provided from filter rods can be manufactured using traditional types of cigarette making techniques. For example, so-called “six-up” filter rods, “four-up” filter rods, and “two-up” filter rods that are of the general format and configuration conventionally used for the manufacture of filtered cigarettes can be handled using conventional-type or suitably modified cigarette rod handling devices, such as tipping devices available as Lab MAX, MAX, MAX S or MAX 80 from Hauni-Werke Korber & Co. KG. See, for example, the types of devices set forth in U.S. Pat. No. 3,308,600 to Erdmann et al.; U.S. Pat. No. 4,281,670 to Heitmann et al.; U.S. Pat. No. 4,280,187 to Reuland et al.; and U.S. Pat. No. 6,229,115 to Vos et al.; and U.S. Patent Application Publication Nos. 2005/0103355 to Holmes and 2005/0194014 to Read, Jr.; each of which is incorporated herein by reference. The operation of those types of devices will be readily apparent to those skilled in the art of automated cigarette manufacture.

Various types of cigarette components, including tobacco types, tobacco blends, top dressing and casing materials, blend packing densities, types of paper wrapping materials for tobacco rods, types of tipping materials, and levels of air dilution, can be employed. See, for example, the various representative types of cigarette components, as well as the various cigarette designs, formats, configurations and characteristics that are set forth in U.S. Pat. No. 5,220,930 to Gentry and U.S. Pat. No. 6,779,530 to Kraker; U.S. Patent Application Publication Nos. 2005/0016556 to Ashcraft et al.; 2005/0066986 to Nestor et al.; 2006/0272655 to Thomas et al.; and 2007/0246055 to Oglesby et al.; each of which is incorporated herein by reference.

Filter rods can be manufactured using a rod-making apparatus, and an exemplary rod-making apparatus includes a rod-forming unit. Representative rod-forming units are available as KDF-2 and KDF-3E from Hauni-Werke Korber & Co. KG; and as Polaris-ITM Filter Maker from International Tobacco Machinery. Filter material, such as cellulose acetate filamentary tow, typically is processed using a conventional filter tow processing unit. For example, filter tow can be bloomed using bussel jet methodologies or threaded roll methodologies. An exemplary tow processing unit has been commercially available as E-60 supplied by Arjay Equipment Corp., Winston-Salem, N.C. Other exemplary tow processing units have been commercially available as AF-2, AF-3 and AF-4 from Hauni-Werke Korber & Co. KG. and as Candor-ITM Tow Processor from International Tobacco Machinery. Other types of commercially available tow processing equipment, as are known to those of ordinary skill in the art, can be employed. Other types of filter materials, such as gathered paper, nonwoven polypropylene web or gathered strands of shredded web, can be provided using the types of materials, equipment and techniques set forth in U.S. Pat. No. 4,807,809 to Pryor et al. and U.S. Pat. No. 5,025,814 to Raker. In addition, representative manners and methods for operating a filter material supply units and filter-making units are set forth in U.S. Pat. No. 4,281,671 to Bynre; U.S. Pat. No. 4,850,301 to Green, Jr. et al.; U.S. Pat. No. 4,862,905 to Green, Jr. et al.; U.S. Pat. No. 5,060,664 to Siems et al.; U.S. Pat. No. 5,387,285 to Rivers and U.S. Pat. No. 7,074,170 to Lanier, Jr. et al.

During use of a filter-making apparatus, a continuous length or web of filter material is supplied from a source such as a storage bale, bobbin, or the like. The continuous length of filter material is pulled through a gathering region of the rod-forming unit. The gathering region can have a tongue and horn configuration, a gathering funnel configuration, a stuffer or transport jet configuration, or other suitable types or combinations of gathering mechanisms. A tongue provides for further gathering, compaction, conversion or formation of a cylindrical composite of filter material into an essentially cylindrical (i.e., rod-like) shape whereby the continuously extending strands or filaments of the filter material extend essentially along the longitudinal axis of the cylinder so formed.

The filter material can vary, and can be any material of the type that can be employed for providing a tobacco smoke filter for cigarettes. Preferably a traditional cigarette filter material is used, such as cellulose acetate tow, gathered cellulose acetate web, polypropylene tow, gathered cellulose acetate web, gathered paper, strands of reconstituted tobacco, or the like. Especially preferred is filamentary tow such as cellulose acetate, polyolefin material such as polypropylene, or the like. One filter material that can provide a suitable filter rod is cellulose acetate tow having 3 denier per filament and 40,000 total denier. As another example, cellulose acetate tow having 3 denier per filament and 35,000 total denier can provide a suitable filter rod. As another example, cellulose acetate tow having 8 denier per filament and 40,000 total denier can provide a suitable filter rod. For further examples, see the types of filter materials set forth in U.S. Pat. No. 3,424,172 to Neurath; U.S. Pat. No. 4,811,745 to Cohen et al.; U.S. Pat. No. 4,925,602 to Hill et al.; U.S. Pat. No. 5,225,277 to Takegawa et al. and U.S. Pat. No. 5,271,419 to Arzonico et al.; each of which is incorporated herein by reference. Typically, filamentary filter materials used for cigarette filter rod manufacture are generally white in color. However, if desired, filamentary filter materials of other colors can be employed. In some instances, the color of the filamentary filter material may correspond to the nature of the smoke modifying agent, such as the flavoring agent, applied thereto by the flavor injection system (e.g., a red color corresponding to a cinnamon flavor, a green color corresponding to a menthol flavor, a black color corresponding to a licorice flavor, or the like).

Before or during the gathering region, objects such as flavor-incorporating strands, capsules, and/or pellets may be inserted into the filter material for inclusion in the final filter rod. Representative types of filter rods incorporating objects, and representative types of cigarettes possessing filter elements incorporating objects, such as flavor-containing strands, capsules, and/or pellets, can possess the types of components, format and configuration, and can be manufactured using the types of techniques and equipment set forth, for example, in U.S. Patent Application Publication Nos. 2005/0070409 A1 to Deal; 2007/0068540 A1 to Thomas et al.; U.S. Pat. No. 4,862,905 to Green, Jr. et al.; and U.S. Patent Application Publication No. 2008/0029118 to Nelson et al.; which are incorporated herein by reference in their entireties.

The material from which the strand is manufactured can vary. Exemplary strands/filament materials can be manufactured from woven natural fiber (e.g., cotton), woven synthetic fiber (e.g., nylon, polyester or cellulose acetate), extruded material (e.g., polyethylene), or the like. Preferred strand materials are woven materials, such as those that can be characterized as string, thread or yarn. The strand material can act as a carrier for a material that can be used to alter the behavior of the mainstream smoke that passes through a filter element incorporating that strand (e.g., the strand can act as a carrier for a smoke modifying agent, such as a flavoring agent). Alternatively, the strand material, when incorporated into the filter rod, does not to any appreciable degree, act as a carrier for a smoke modifying agent (i.e., the strand material, as provided from the spool, is virtually devoid of added flavoring agent and does not act as a smoke modifying agent). If desired, the strand material optionally can be removed from its spool, passed through a flavoring agent applicator system (e.g., passed through a bath of flavoring agent and liquid carrier or sprayed with a mist of flavoring agent and liquid carrier) prior to being introduced into the filter material cylindrical composite. In other instances, the strand material can be configured to absorb or “wick” a flavoring agent from surrounding material, such as the filter material, once the strand is introduced into the filter material cylindrical composite. The strand material also possesses appropriate physical properties, such as pliability, tensile strength, and the like. Exemplary thread is available from Service Thread Manufacturing Co. as Product Number M-04/01-COTN-WHT-OENF-4.25#. Such a type of thread can be treated with dyes or other coloring agents of the desired type in order to provide a thread of the desired color.

If desired, so-called “non-wrapped acetate” filter rods possessing a strand material extending generally longitudinally therethrough also can be produced. Such rods are produced using the types of techniques generally set forth herein. However, rather than employing a plug wrap material that circumscribes the longitudinally extending periphery of the filter rod, a somewhat rigid rod is provided by plasticizing the cellulose acetate tow and applying steam to that gathered tow. Techniques for commercially manufacturing non-wrapped acetate filter rods are possessed by Filtrona Corporation, Richmond, Va. The rod-making unit employed to manufacture those types of filter rods can be suitably adapted to possess the type of strand insertion unit set forth herein.

A representative filter element may possess one or more strands at predetermined positions therein with respect to the cross-section thereof. For example, the number of strands longitudinally extending through the filter element can number 1, 2 or 3. A plurality of strands can be incorporated within a filter element by suitably adapting the previously described strand insertion unit to provide a plurality of strands from a plurality of spools through a single appropriately modified strand insertion device. Alternatively, a plurality of strands can be incorporated within a filter element by suitably adapting the previously described strand insertion unit to provide a plurality of strands from a plurality of spools through an appropriate number (plurality) of strand insertion devices.

Preferably, for a filter element having a generally circular cross-sectional shape, that filter element contains a single strand positioned therein; wherein that strand is centrally located within the filter element (e.g., the strand is located in the center of the cross-section of the filter element). An exemplary filter element preferably contains one strand having a generally circular cross-sectional shape, and that strand has diameter of at least about 0.5 mm, typically at least about 0.75 mm, and often at least about 1 mm. Typically, that strand has a diameter that does not exceed about 2.5 mm, often do not exceed about 2 mm, and frequently do not exceed about 1.5 mm. Certain preferred strands are generally circular in cross-sectional shape, and have diameters in the range of about 0.5 mm to about 2 mm in diameter, and certain highly preferred strands are about 0.75 mm to about 1.25 mm in diameter. In addition, strands can possess cross-sectional shapes other than circular. For example, strands can possess cross-section shapes that can be considered to be oval, square, rectangular, triangular, hexagonal, octagonal, star-shaped, or the like. Typically, the minimum and maximum cross-sectional widths of those strands are comparable to those diameters set forth hereinbefore for those strands that are circular in cross-sectional shape. Preferably, the strand material is disposed within the filter material of the filter element, particularly towards the central lateral region of the filter element. Most preferably, the nature of the filter material is such that the strand is secured or lodged in place within the filter element.

In particular instances where a strand is inserted into the filter material during the filter rod forming process, the filter material that has been gathered/compressed into a substantially cylindrical composite, and which now includes a continuous strand of material such as a filament material, is received further into a garniture region. That is, the cylindrical composite is fed into a wrapping mechanism, which includes an endless garniture conveyer belt. The garniture conveyer belt is continuously and longitudinally advanced using an advancing mechanism such as a ribbon wheel or cooperating drum so as to transport the cylindrical composite through the wrapping mechanism. The wrapping mechanism provides and applies a strip of wrapping material, such as a web of porous or non-porous paper plug wrap, to the outer surface of the cylindrical composite in order to produce continuous wrapped rod.

The strip or web of wrapping material is provided from rotatable bobbin or another suitable source. The wrapping material is drawn from the bobbin, is trained over a series of guide rollers, and enters the wrapping mechanism of the rod-forming unit. The endless garniture conveyer belt transports both the strip of wrapping material and the cylindrical composite downstream in a longitudinally extending manner through the wrapping mechanism while draping or enveloping the wrapping material about the cylindrical composite.

The seam formed by an overlapping marginal portion of wrapping material has adhesive (e.g., hot melt adhesive) applied thereto at applicator region in order that the wrapping material can form a tubular container for the filter material. Alternatively, the hot melt adhesive may be applied directly upstream of the wrapping material's entry into the garniture region of the wrapping mechanism. The adhesive can be cooled using a chill bar in order to cause rapid setting of the adhesive. It is understood that various other sealing mechanisms and other types of adhesives can be employed in providing the continuous wrapped rod. As such, there is provided a manner or method for supplying a continuous supply of plug wrap, circumscribing the longitudinal periphery of a continuous supplied filter material gathered composite, and hence forming a continuous filter rod circumscribed by plug wrap.

The continuous wrapped rod passes from the sealing mechanism and is subdivided (e.g., severed) at regular intervals at the desired, predetermined length using a cutting assembly, which includes as a rotary cutter, a highly sharpened knife, or other suitable rod cutting or subdividing mechanism. It is particularly desirable that the cutting assembly does not flatten or otherwise adversely affect the cross-sectional shape of the rod. As such, the filter material supplied to a filter-making unit is formed into a continuous rod, which is subdivided, using a rod cutting assembly, into a plurality of filter rods or rod portions. The succession or plurality of rod portions are collected for further use, using a tray, a rotary collection drum, conveying system, or the other suitable collection mechanism. In some instances, the rod portions can be forwarded directly toward a cigarette making machine. In such a manner as disclosed herein, a continuous filter rod can be manufactured at a rate of greater than about 200 meters per minute, often greater than about 300 meter per minute, and frequently greater than about 400 meters per minute. Rod sizes for use in the manufacture of filter elements for cigarettes can vary, but typically range in length from about 80 mm to about 140 mm, and from about 16 mm to about 27 mm in circumference. For example, a typical rod having a 100 mm length and a 24.53 mm circumference exhibits a pressure drop of from about 200 mm to about 400 mm of water as determined at an airflow rate of 17.5 cc/sec using an encapsulated pressure drop tester, sold commercially as Model No. FTS-300 by Filtrona Corporation, Richmond, Va.

However, as previously discussed, it is possible that such apparatuses and processes for inserting a strand within the filter rod may produce some filter rods or portions thereof that are not formed in the desired configuration. That is, the strand inserted within a filter rod may be, for instance, missing, misaligned, or otherwise improperly inserted. Further, the strand may be, for example, an improper color, an improper size, or an improper material. Any or all of these factors may undesirably affect, for example, the aesthetic quality, or in some instances the functionality, of the end product. As such, it may be desirable to be able to detect such “abnormal” filter rods or portions thereof, after the rod portions have been formed, such that those “abnormal” filter rods, or at least the defective portion(s) thereof, can be removed from the manufacturing process prior to being used to form the smoking articles. In this manner, for example, the yield of the manufacturing process for such smoking articles may be increased, and smoking articles having such “abnormal” filter rods may be prevented from reaching consumers.

Thus, embodiments of the present invention are directed to systems and methods for inspecting filter rods used to form cigarette filter elements, prior to such filter rods or portions thereof being directed to a cigarette making machine/cigarette forming process. Each filter rod typically defines a longitudinal axis extending between opposed ends, with each end extending substantially perpendicularly to the longitudinal axis, and includes a filter material having an axially-extending strand disposed therein. As such, the disclosed system comprises a filter rod support device adapted to receive at least one filter rod such that one end thereof is exposed. An analysis unit is disposed with respect to the filter rod support device so as to interact with the one end of the at least one filter rod to determine a status of the at least one filter rod and to provide a corresponding signal in response thereto, such that appropriate action may be taken with respect to the analyzed filter rod upon determination of the status.

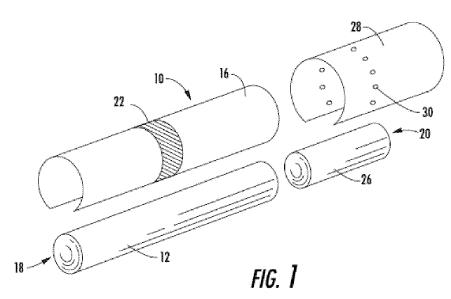

Referring to FIG. 1, there is shown a smoking article 10 in the form of a cigarette and possessing certain representative components of a smoking article. The cigarette 10 includes a generally cylindrical rod 12 of a charge or roll of smokable filler material contained in a circumscribing wrapping material 16. The rod 12 is conventionally referred to as a “tobacco rod.” The ends of the tobacco rod 12 are open to expose the smokable filler material. The cigarette 10 is shown as having one optional band 22 (e.g., a printed coating including a film-forming agent, such as starch, ethylcellulose, or sodium alginate) applied to the wrapping material 16, wherein that band circumscribes the cigarette rod in a direction transverse to the longitudinal axis of the cigarette. That is, the band 22 provides a cross-directional region relative to the longitudinal axis of the cigarette. The band 22 can be printed on the inner surface of the wrapping material (i.e., facing the smokable filler material), or less preferably, on the outer surface of the wrapping material. Although the cigarette can possess a wrapping material having one optional band, the cigarette can also possess wrapping material having further optional spaced bands numbering two, three, or more.

At one end of the cigarette 10 is the lighting end 18 of the tobacco rod 12, and at the mouth end 20 is positioned a filter rod 26. The filter rod 26 positioned adjacent one end of the tobacco rod 12 such that the filter rod and tobacco rod are axially aligned in an end-to-end relationship, preferably abutting one another. The filter rod 26 may have a generally cylindrical shape, and the diameter thereof may be essentially equal to the diameter of the tobacco rod. The ends of the filter rod 26 permit the passage of air and smoke therethrough.

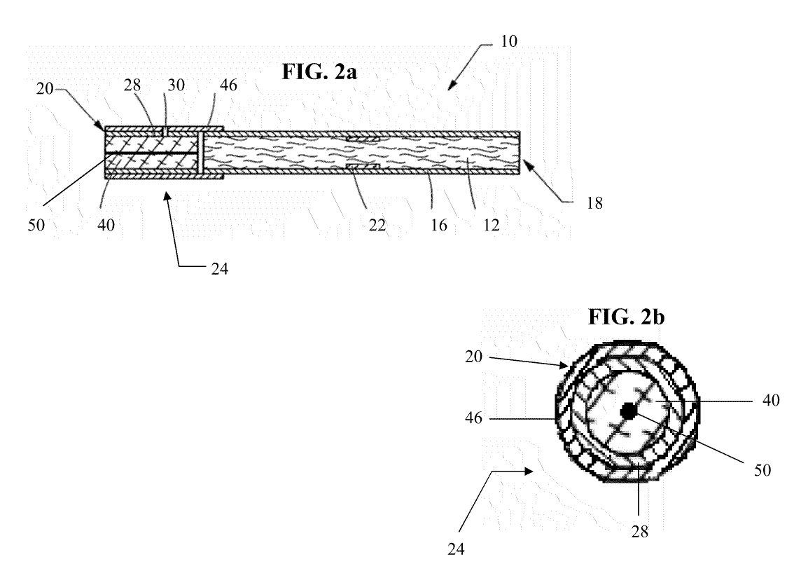

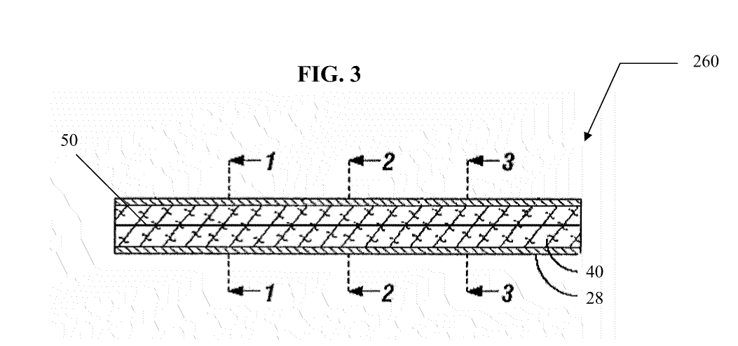

In some instances, the smoking article 10 may be configured as shown in FIG. 2a, wherein the filter element 24 includes filter material 40 (e.g., cellulose acetate tow) that is over-wrapped along the longitudinally extending surface thereof with circumscribing plug wrap material 28. That is, the filter element 24 is circumscribed along its outer circumference or longitudinal periphery by a layer of plug wrap 28, and each end is open to expose the filter material 40. Further, as shown in FIGS. 2a and 2b, the filter material 40 may include a generally longitudinally extending strand 50 within the filter material. FIG. 2b shows the lateral face of the filter element 24, and the longitudinally extending strand 50 within the filter material 40 is shown to be desirably disposed about the center of the filter element 24, in one particular configuration of an appropriate filter element 24.

The filter element 24 is attached to the tobacco rod 12 using tipping material 46 (e.g., an essentially air-impermeable tipping paper), that circumscribes both the entire length of the filter element 24 and an adjacent region of the tobacco rod 12. The inner surface of the tipping material 46 is fixed securely to the outer surface of the plug wrap 28 and the outer surface of the wrapping material 16 of the tobacco rod, using a suitable adhesive; and hence, the filter element and the tobacco rod are connected to one another. See also the tipping materials and configurations set forth in U.S. Patent Publication No. 2008/0029111 to Dube et al., which is incorporated by reference herein.

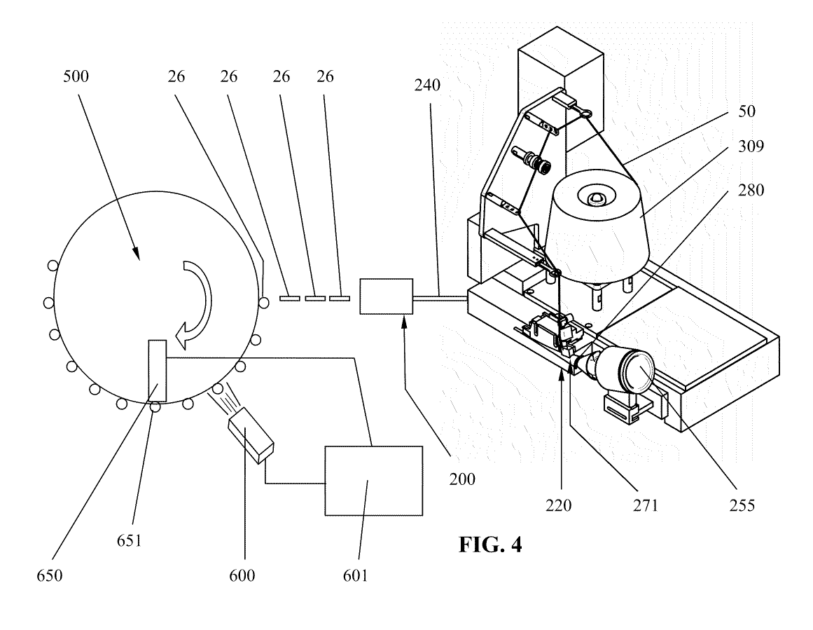

Referring to FIG. 3, the filter elements 24 are generally obtained by subdividing a continuous filter rod 260 into a plurality of cylindrically-shaped filter elements or rod portions using techniques as are known by the skilled artisan familiar with conventional cigarette manufacturing. The continuous filter rod 260 includes the filter material 40 encased in the circumscribing wrapping material 28 such as conventional air permeable or air impermeable paper plug wrap, or other suitable wrapping material. In one embodiment, at least one strand 50 may be disposed along the longitudinal axis of and within the rod 260 and, in some instances, is preferably disposed about the center of the cross-section of the filter rod 260, so as to be subdivided along with the filter rod 260.

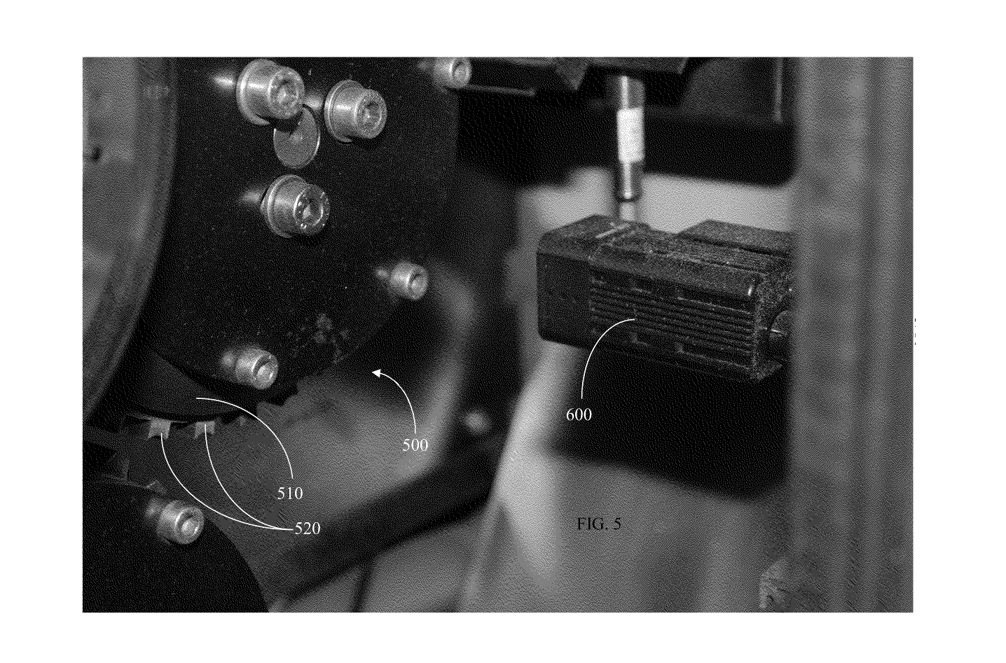

FIG. 4 shows a schematic of a portion of a rod-making unit 200, such as available as KDF-2 from Hauni-Werke Korber & Co. KG. The rod-forming unit may be equipped with a strand insertion unit 220, which is suitably adapted to provide for placement of continuous strand of material 50, such as a filament material, within a continuous length of filter material (not shown). The representative rod-making unit is arranged so that the filter material is fed into the tongue 280 from a stuffer jet device 255. Components of the strand insertion unit 220 are positioned in the filter material gathering region 271 of the rod-forming unit. The strand insertion unit 220 possesses an insertion tube that extends through the tongue 280. The strand insertion unit also possesses a spool 309, bobbin, or other mechanism for providing a continuous supply of strand-like filament material 50 (e.g., thread can be supplied from a spool). The strand 50 passes through a series of guides and through the insertion tube. The spool 309 can be located and supported on a spool support base positioned on and secured to, an appropriate region of the rod-forming unit 200. The strand can be removed from the spool at an appropriate rate and effectively guided through the insertion tube during operation of the rod-making unit.

During use, the filter material (not shown), such as plasticized cellulose acetate tow is fed into the stuffer jet 255, and then passes in the downstream direction into the tongue 280. The continuous strand is then introduced into the filter material, through the insertion tube in the tongue 280. The filter material and the strand cooperate to form a continuous cylindrical composite 240 passed downstream through the rod-forming unit. The continuous cylindrical composite travels downstream through the rod-forming unit, and is eventually subdivided to form a plurality of individual filter rods or elements 26. In this manner, there may be sufficient variability within the various components of the rod-forming unit such that the strand may not be disposed, as desired or specified, within the individual filter rods 26.

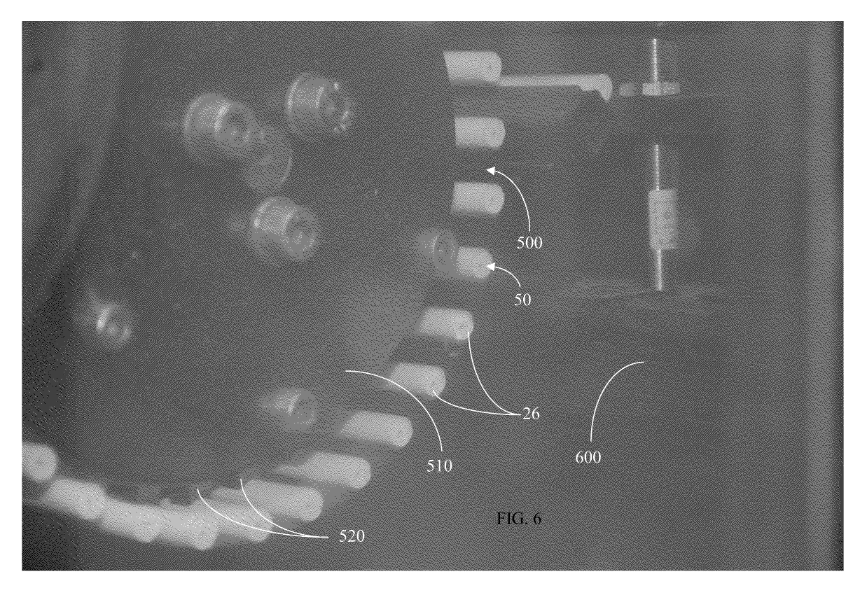

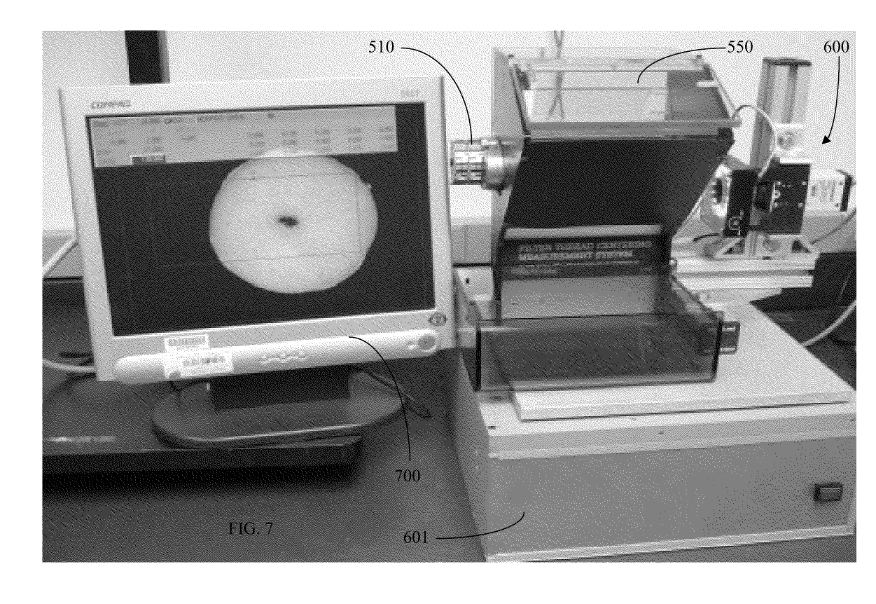

As further shown in FIGS. 4-6, once the plurality of filter elements 26 are formed, the filter rods/elements 26 may be directed to or otherwise become engaged with a filter rod support device 500, either online or offline with respect to the rod-forming unit, such that at least one longitudinal end (i.e., a surface extending perpendicularly to the axis defined by the filter rod 26) thereof is exposed. In one aspect, as shown in FIGS. 4-6, the filter rod support device 500 may be configured as, for example, a rotatable wheel 510 defining an axis and having an outer periphery, wherein the periphery includes a plurality of filter rod receiving devices 520 such as, for example, a plurality of channels, each extending parallel to the axis. The channels 520 may be configured to selectively attract and retain respective filter rods 26. For instance, each channel 520 may define a suction port (not shown) engaged with a suction or vacuum source (not shown). As such, when the filter rods 26 are introduced to the rotatable wheel 510 of the filter rod support device 500, the suction applied to the filter rod receiving devices 520 attracts respective filter rods 26 and secures the filter rods to the rotatable wheel 510. In one configuration, the channels 520 are configured to interact with the axially-extending peripheral surface of the filter rods 26 (i.e., the surface formed by the plug wrap material 28) such that either or both ends (i.e., the surface of the filter rod 26 extending substantially perpendicularly to the axis defined by the filter rod 26) of the filter rods 26 are exposed. In another aspect, as shown in FIG. 7, the filter rod support device 500 may have a hopper device 550 operably engaged therewith for feeding the filter rods 26 to the rotatable wheel 510.

According to one aspect, an analysis unit 600 is disposed with respect to the filter rod support device 500 so as to interact with the one end of at least one filter rod 26 so as to determine a status of that filter rod 26 and to provide a corresponding signal in response to the determined status. That is, the analysis unit 600 may interact with only one end of the filter rod 26, or may be configured to analyze both ends of the filter rod 26 (i.e., simultaneously or in succession). In other instances, the analysis unit 600 may comprise two separate analysis components (not shown), wherein each component is configured to interact with a respective end of the filter rod 26 (i.e., analysis of both ends of the filter rod 26 would allow the determination of, for example, whether the strand 50 extended completely through the filter rod 26, or whether the strand 50 maintained the same alignment between both ends of the filter rod 26).

In one aspect, the analysis unit 600 may be particularly configured as an image analysis unit for analyzing an image of the end of filter rod 26. That is, the analysis unit 600 may comprise an image acquisition device, such as a CCD camera, for capturing the image of the end of the filter rod. An exemplary analysis unit 600 may be, for example, a ZFV Series Smart Sensor with Ultra-High-Speed ZFV-SR50 CCD Camera (with ZFV-A25 amplifier unit), commercially available from OMRON, operating in an “Area” mode to visually identify and inspect the strand 50 within the filter rod 26 via an image thereof. The analysis unit 600 may, in some instances, comprise a computer device 601 in communication with the sensor/camera/amplifier for analyzing the data (image) collected thereby to determine a status of the analyzed filter rod 26.

The status of the filter rod 26 may comprise, for example, a strand presence within the filter rod, a strand absence from the filter rod, an acceptable strand presence in the filter rod, an unacceptable strand presence in the filter rod, and combinations thereof. Further, the acceptable strand presence in the filter rod and the unacceptable strand presence in the filter rod may each be determined with respect to a characteristic, wherein the characteristic may be selected from, for example, the strand disposition within the filter material, the strand alignment within the filter material, the strand configuration, the strand type, the strand color, the strand size, the strand condition, and combinations thereof.

Upon determining the status of the filter rod 26 from analysis of an image of at least one of the ends thereof, the analysis unit 600 (i.e., the computer device 601) may be configured to generate an output signal in response to the status. In such instances, a display unit 700 (see, e.g., FIG. 7) may be in communication with the analysis unit 600 for receiving the output signal therefrom. The display unit may be further configured to be responsive to the signal so as to display an indicia corresponding to the determined status, whether acceptable or unacceptable. For example, the display unit may be configured to display a flashing red “X” along with the particular status (i.e., “no strand detected”) when an unacceptable filter rod 26 is analyzed. On the other hand, the display unit may be configured to display a green check mark, along with the particular status (i.e., “acceptable strand detected”) when an acceptable filter rod 26 is analyzed. One skilled in the art will appreciate, however, that the status does not necessarily need to be displayed, but, if “displayed,” need not necessarily be indicated in a visual manner. For example, the “display device” may be configured to produce an aural indicia such that an acceptable filter rod has been analyzed.

In another aspect, a filter rod removal device 650 may be in communication with the analysis unit 600 and operably engaged with the filter rod support device 500. The filter rod removal device 650 may be configured, for example, to be responsive to an unacceptable status (i.e., the strand absence from the filter rod and the unacceptable strand presence in the filter rod) to discard or otherwise remove an unacceptable filter rod 651 from the filter rod support device 500, or at least ascertain that the unacceptable filter rod 651 is identified for removed from the process prior to being used to form a smoking article. Further, the analysis unit 600 (i.e., the computer device 601) may be further configured to halt the filter rod analysis process if, for example, a threshold number of successive or substantially successive filter rods are determined to have an unacceptable status. In such an instance, the analysis unit 600 may also be configured to provide an appropriate corresponding indicia that such action was taken is response to the “unacceptable” threshold amount being surpassed. In other aspects, the analysis unit 600 may also be configured so as to collect and store status data with respect to the filter rods 26 analyzed thereby.

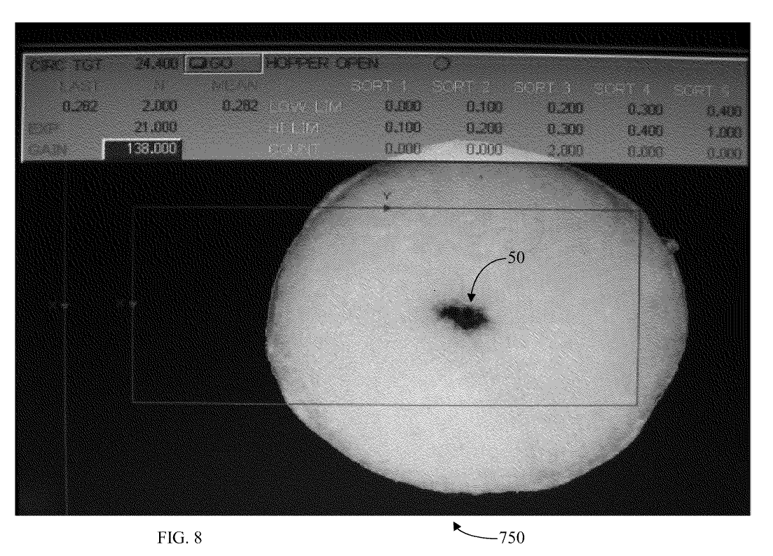

As shown in FIG. 7, the analysis unit 600 (i.e., a Cognex camera/vision system) may alternately be configured to provide dimensional analysis of the strand 50 within the filter rod 26 through analysis of one of the ends of the filter rod 26 (i.e., to determine if the strand 50 is centered within the cross-section of the filter rod 26). In doing so, the filter rods 26 are deposited into a hopper 550 and automatically fed to and positioned by a filter rod support device 500 (i.e., rotatable wheel 510) such that at least one end of each filter rod 26 may be accessed by a visual analysis device for interaction therewith. The visual analysis device of the analysis unit 600 may be configured to determine, from an image 750 (see, e.g., FIG. 8) of the end of the filter rod 26, the preferred disposition of the strand 50 with respect to the cross-section, in comparison to the actual disposition of the strand 50 with respect to the cross-section. In one instance, the preferred disposition of the strand 50 may be about the center of the cross-section. As such, the analysis unit 600 may be configured to provide an indication of the accuracy of the placement of the strand 50 (i.e., whether the strand 50 is centered) with respect to the cross-section of the filter rod 26. For example, the accuracy measurement (i.e., the distance between the actual disposition and the preferred disposition of the strand 50) of each filter rod 26 in substantially real time, as well as number of filter rods 26 and an average accuracy value for the plurality of filter rods 26 analyzed by the analysis unit 600. Individual accuracy values may also be output to allow for further analysis and data collection. In some instances, the accuracy values may be sorted according to various ranges, and the analysis unit 600 further configured to determine the amounts of filter rods 26 having accuracy values within those ranges.

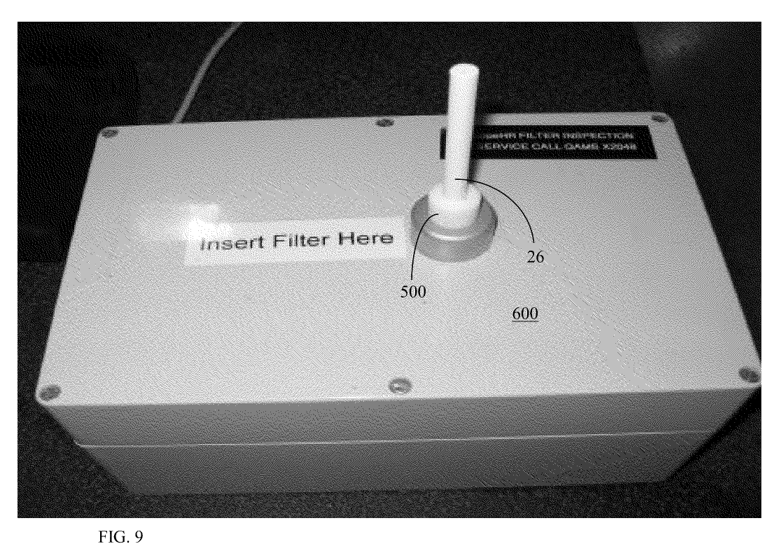

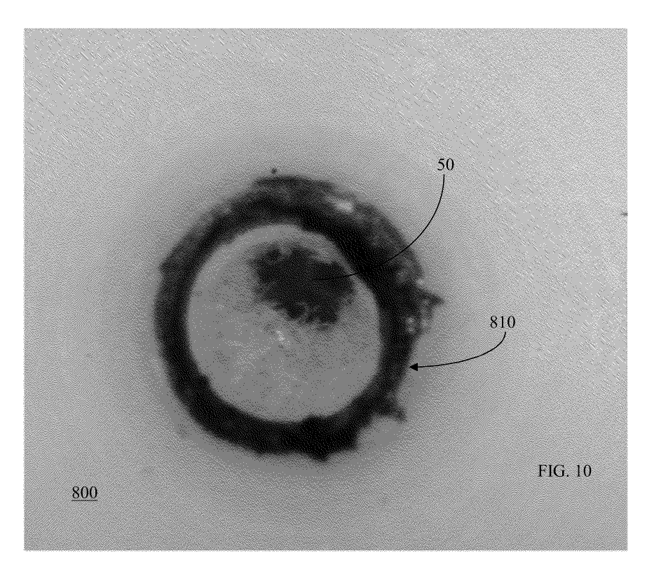

As shown in FIG. 9, another alternate aspect of the present invention may include a filter rod support device 500 configured to receive individual filter rods 26 for allowing expedient “spot checks” with respect to a plurality or “batch” of particular filter rods 26. In such an instance, the “analysis unit 600” (i.e., a ProscopeHR USB microscope) paired therewith may be configured for automatic or manual analysis of the end of the filter rod 26 for determining the status thereof (i.e., with respect to the disposition of the strand 50 therein). For example, the filter rod support device 500 may be configured to receive the filter rod 26 such that a gauge member 800 is disposed about the end of the filter rod 26 to be analyzed, as shown in FIG. 10. The gauge member 800 defines an aperture 810 corresponding, for example, to a range of acceptable dispositions of the strand 50 with respect to the cross-section of the filter rod 26. A magnifying device (not shown) such as, for example, a microscope, may be directed toward the gauge member 800/aperture 810 so as to provide a magnified view of the end of the filter rod 26 therethrough, wherein such a magnified view may be manually evaluated by an operator, or provided as an image on an associated display device (not shown). In some instances, a visual analysis device, as otherwise disclosed herein, may be configured to interact with the gauge member 800/aperture 810 so as to provide for automatic evaluation of the disposition of the strand 50 with respect to the cross-section of the filter rod 26.

Many modifications and other embodiments of the invention will come to mind to one skilled in the art to which this invention pertains having the benefit of the teachings presented in the foregoing description; and it will be apparent to those skilled in the art that variations and modifications of the present invention can be made without departing from the scope or spirit of the invention. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for inspecting filter rods used to form cigarette filter elements, each filter rod defining a longitudinal axis extending between opposed ends, each end extending substantially perpendicularly to the longitudinal axis, and including a filter material having an axially-extending strand disposed therein, the system comprising:
a filter rod support device adapted to receive at least one filter rod such that one end thereof is exposed; and
an analysis unit disposed with respect to the filter rod support device so as to interact with the one end of the at least one filter rod to determine a status of the at least one filter rod and to provide a corresponding signal in response thereto.

2. A system according to claim 1 wherein the filter rod support device is configured to support the at least one filter element such that both ends are exposed, and the analysis unit is configured to interact with both ends of the at least one filter rod to determine the status of the at least one filter rod.

3. A system according to claim 1 wherein the analysis unit further comprises an image analysis unit configured to analyze an image of the at least one filter rod.

4. A system according to claim 3 wherein the image analysis unit further comprises an image acquisition device for capturing the image of the at least one filter rod.

5. A system according to claim 3 further comprising a display unit in communication with the analysis unit, the display unit being responsive to the signal so as to display an indicia corresponding to the determined status.

6. A system according to claim 1 wherein the status of the at least one filter rod further comprises at least one of a strand presence within the filter rod, a strand absence from the filter rod, an acceptable strand presence in the filter rod, and an unacceptable strand presence in the filter rod.

7. A system according to claim 6 wherein the acceptable strand presence in the filter rod and the unacceptable strand presence in the filter rod are each determined with respect to a characteristic selected from the group consisting of strand disposition within the filter material, strand alignment within the filter material, strand configuration, strand type, strand color, strand size, strand condition, and combinations thereof.

8. A system according to claim 6 further comprising a filter rod removal device operably engaged with the analysis unit and the filter rod support device, the filter rod removal device being responsive to the signal so as to remove the at least one filter rod from the filter rod support device and to discard the at least one filter rod when the status corresponds to one of the strand absence from the filter rod and the unacceptable strand presence in the filter rod.

9. A system for inspecting filter rods used to form cigarette filter elements, each filter rod defining a longitudinal axis extending between opposed ends, each end extending substantially perpendicularly to the longitudinal axis, and including a filter material having an axially-extending strand disposed therein, the system comprising:
filter rod support means adapted to receive at least one filter rod such that one end thereof is exposed; and
analysis means disposed with respect to the filter rod support means so as to interact with the one end of the at least one filter rod to determine a status of the at least one filter rod and to provide a corresponding signal in response thereto.

10. A system according to claim 9 wherein the filter rod support means is configured to support the at least one filter element such that both ends are exposed, and the analysis means is configured to interact with both ends of the at least one filter rod to determine the status of the at least one filter rod.

11. A system according to claim 9 wherein the analysis means further comprises image analysis means configured to analyze an image of the at least one filter rod.

12. A system according to claim 11 wherein the image analysis means further comprises an image acquisition means for capturing the image of the at least one filter rod.

13. A system according to claim 11 further comprising display means in communication with the analysis means, the display means being responsive to the signal so as to display an indicia corresponding to the determined status.

14. A system according to claim 9 wherein the status of the at least one filter rod further comprises at least one of a strand presence within the filter rod, a strand absence from the filter rod, an acceptable strand presence in the filter rod, and an unacceptable strand presence in the filter rod.

15. A system according to claim 14 wherein the acceptable strand presence in the filter rod and the unacceptable strand presence in the filter rod are each determined with respect to a characteristic selected from the group consisting of strand disposition within the filter material, strand alignment within the filter material, strand configuration, strand type, strand color, strand size, strand condition, and combinations thereof.

16. A system according to claim 14 further comprising filter rod removal means operably engaged with the analysis means and the filter rod support means, the filter rod removal means being responsive to the signal so as to remove the at least one filter rod from the filter rod support means and to discard the at least one filter rod when the status corresponds to one of the strand absence from the filter rod and the unacceptable strand presence in the filter rod.

17. A method for inspecting filter rods used to form cigarette filter elements, each filter rod defining a longitudinal axis extending between opposed ends, each end extending substantially perpendicularly to the longitudinal axis, and including a filter material having an axially-extending strand disposed therein, the method comprising:
receiving at least one filter rod in a filter rod support device such that one end of the at least one filter rod is exposed;
analyzing the one end of the at least one filter rod using an analysis unit;
determining a status of the at least one filter rod from the analysis of the one end; and
providing a signal in response to and corresponding to the determined status.

18. A method according to claim 17 wherein receiving the at least one filter rod further comprises receiving the at least one filter rod such that both ends are exposed, and the analyzing step further comprises analyzing at least one of the ends of the at least one filter rod to determine the status of the at least one filter rod.

19. A method according to claim 17 wherein the analyzing step further comprises analyzing an image of the one end of the at least one filter rod using an image analysis unit.

20. A method according to claim 19 further comprising capturing the image of the at least one filter rod using an image acquisition device.

21. A method according to claim 19 further comprising displaying, in response to the signal, an indicia corresponding to the determined status on a display unit in communication with the analysis unit.

22. A method according to claim 17 wherein determining a status of the at least one filter rod further comprises determining at least one of a strand presence within the filter rod, a strand absence from the filter rod, an acceptable strand presence in the filter rod, and an unacceptable strand presence in the filter rod.

23. A method according to claim 22 wherein determining a status of the at least one filter rod further comprises determining one of an acceptable strand presence in the filter rod and an unacceptable strand presence in the filter rod with respect to a characteristic selected from the group consisting of strand disposition within the filter material, strand alignment within the filter material, strand configuration, strand type, strand color, strand size, strand condition, and combinations thereof.

24. A system according to claim 22 further comprising removing, in response to the signal, the at least one filter rod from the filter rod support device using a filter rod removal device operably engaged with the analysis unit and the filter rod support device, and discarding the at least one filter rod, when the status corresponds to one of the strand absence from the filter rod and the unacceptable strand presence in the filter rod.
